(19) United States
(12) Patent Application Publication
(10) Pub. No.: US 2014/0015942 A1
(43) Pub. Date: Jan. 16, 2014

(54) ADAPTIVE MONOSCOPIC AND STEREOSCOPIC DISPLAY USING AN INTEGRATED 3D SHEET

(71) Applicant: Amir Said, Cupertino, CA (US)

(72) Inventor: Amir Said, Cupertino, CA (US)

(21) Appl. No.: 14/008,710

(22) PCT Filed: Mar. 31, 2011
(86) PCT No.: PCT/US2011/030799

§ 371 Date: Sep. 30, 2013

(51) Int. Cl. H04N 13/04

(52) U.S. Cl. CPC H04N 13/0404
USPC 348/59

(57) ABSTRACT

An adaptive monoscopic and stereoscopic display system is disclosed. The display system includes a display, a 3D sheet mounted to the display, and a processor to adapt the display according to whether the 3D sheet is mounted to the display. The display includes at least one lock to hold the 3D sheet in place and at least one sensor to facilitate alignment of the 3D sheet and calibration of the display.

### BACKGROUND

Autostereoscopic displays have emerged to provide viewers a visual reproduction of three-dimensional (“3D”) real-world scenes without the need for specialized viewing glasses. Examples include holographic, volumetric, or parallax displays. Holographic and volumetric displays often require very large data rates and have so far been of limited use in commercial applications. Parallax displays rely on existing two-dimensional (“2D”) display technology and are therefore easier and less costly to implement.

A simple parallax display system may be built out of a conventional 2D display (e.g., LCD), a lenticular array mountable in front of the conventional display, and eye tracking software coupled with a camera built into the conventional display to identify the position of a viewer's eyes. The lenticular array directs different views accordingly, thus providing a unique image to each eye. The viewer's brain then compares the different views and creates what the viewer sees as a single 3D image. This type of display system is intended for a single viewer, and comes with the drawback that resolution is lost at least a half horizontally (commonly more, including some loss of vertical resolution) to achieve the different views. As a result, the displayed image is degraded, making it difficult for the viewer to read small text or interpret other image features.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example of a 3D sheet for use with an adaptive monoscopic and stereoscopic display system;

FIG. 2 illustrates a two-view lenticular-based display system;

FIG. 3 is an example of a locking mechanism for aligning a removable 3D sheet with a display in an adaptive monoscopic and stereoscopic display system;

FIG. 4 is another example of a locking mechanism for aligning a removable 3D sheet with a display in an adaptive monoscopic and stereoscopic display system;

FIG. 5 is another example of a locking mechanism for aligning a removable 3D sheet with a display in an adaptive monoscopic and stereoscopic display system;

FIG. 6 is an example flowchart for operating an adaptive monoscopic and stereoscopic display system; and

FIG. 7 is a block diagram of an example of a computing system for controlling the adaptive monoscopic and stereoscopic display according to the present disclosure.

### DETAILED DESCRIPTION

An adaptive monoscopic and stereoscopic display system is disclosed. The system enables users to use a removable or switchable 3D sheet as desired to display 3D images while adapting the displayed images accordingly. The 3D sheet may be either a lenticular array or a parallax barrier, or any other sheet capable of providing 3D images to viewers when integrated to a 2D display. A lenticular array, as generally described herein, consists of a sheet (such as a plastic sheet) of very small, parallel and cylindrical lenses that are used to produce images with an illusion of depth, or the ability to change or move as the image is viewed from different angles. When viewed from different angles, different images/areas under the lenses are magnified. A parallax barrier, as generally described herein, consists of a layer of material with a series of precision slits that allows viewers to see a stereoscopic image without the need for special viewing glasses.

In various embodiments, the adaptive monoscopic and stereoscopic display system includes a conventional 2D display (e.g., LCD), a 3D sheet mountable in front of the display, and software coupled with a camera built into the display to control various features of the display and adapt it for use with the 3D sheet. The 3D sheet is integrated to the display using a locking mechanism including at least one lock that allows the 3D sheet to be aligned with the display with precision, accuracy, and consistency. The locking mechanism incorporates one or more sensors to detect when the 3D sheet is placed on top of the display and to estimate the position of the 3D sheet relative to the pixels in the display. Directional light sensors may also be integrated with a keyboard connected to the display to help identify and correct the 3D sheet/pixels alignment.

The 3D sheet may be removed by a viewer at any time. When the 3D sheet is present, the display is in effect a stereoscopic display enabling a viewer to see 3D images without the use of specialized viewing glasses. When the 3D sheet is not present, the display is a regular monoscopic display presenting 2D images to the viewer. To address the loss in resolution introduced by the 3D sheet, the display adapts its user interface so a different user interface is presented to the viewer when the 3D sheet is present. The user interface adapts the size of fonts, icons, and other imagery and adds blurring to reduce aliasing. Fine tuning and automatic calibration of the display is also implemented to determine which pixels are visible from a given view point and to target the views according to the position of a viewer's eyes. This is also needed on displays with integrated switchable (instead of removable) 3D sheets (i.e., lenticular arrays or parallax barriers). These switchable 3D sheets may be turned on and off to provide either 3D (when on) or 2D (when off) images to viewers.

It is appreciated that embodiments of the adaptive monoscopic and stereoscopic display system described herein below may include additional components and features. Some of the components and features may be removed and/or modified without departing from a scope of the adaptive monoscopic and stereoscopic display system. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phases in various places in the specification are not necessarily all referring to the same embodiment.

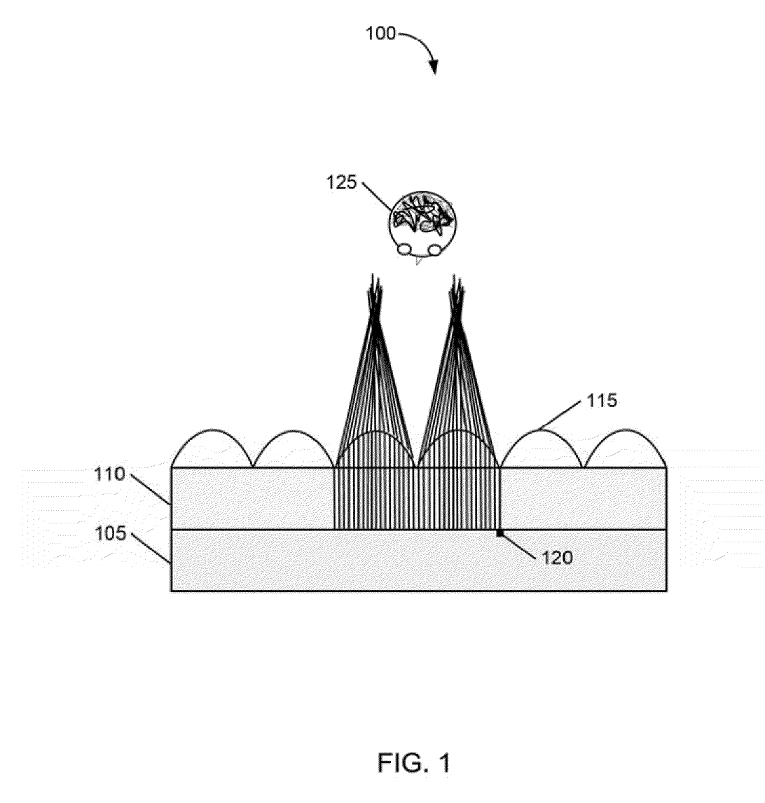

Referring now to FIG. 1, an example of a 3D sheet for use with an adaptive monoscopic and stereoscopic display system is illustrated. Display system 100 has a conventional 2D display 105 such as a LCD and a 3D sheet 110 placed on top of the display 105. The 3D sheet 110 is a lenticular array sheet (e.g., a plastic, transparent sheet) composed of many small and adjacent vertically-aligned lenticules or lenslets (e.g., lenticule 115), which are typically long and narrow cylindrical lenses that are used to produce images with an illusion of depth. Each lenticule directs the light from a single sub-pixel (e.g., sub-pixel 120) towards a particular direction as illustrated. The focal plane of the lenticules is positioned at (or close to) the pixel plane of the display 105 so that light from the pixels in the display 105 is collimated towards the viewer (e.g., viewer 125) into different directions. Multiple sub-pixels under a single lenticule are therefore directed in different directions to form multiple views.

The number of views provided is equal to the ratio between the lens pitch and the sub-pixel pitch. The lens pitch is the count of lenticules per inch in a certain lenticular array and the sub-pixel pitch is the physical distance between the sub-pixels in the display. If, for example, the pitch of the lens equals five times the sub-pixel pitch, then five views are generated. The optimal number of views depends on the application. For mobile applications, a five-view system is often used, whereas for laptop, desktop and TV applications with larger displays, a nine-view (or higher view) system is preferred.

A common drawback of a display system employing a lenticular array such as the display system 100, using the 3D sheet 110 is the loss in resolution. The generation of views using vertically-aligned lenticules decreases the resolution in the horizontal direction, with a loss in resolution at least equal to the number of views. The loss in resolution makes it difficult, if not impossible, to read small text and interpret icons and other small imagery on the display screen.

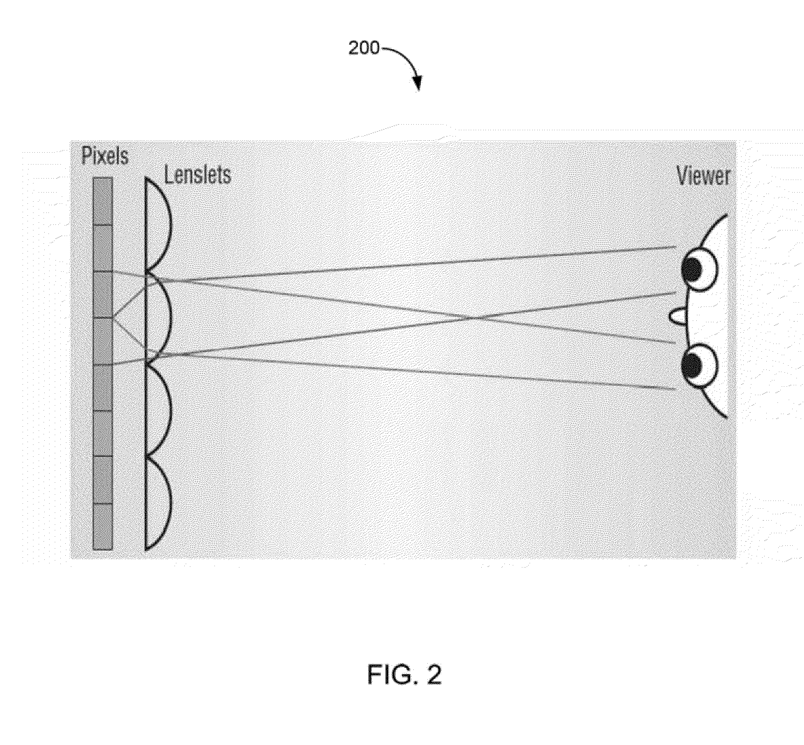

FIG. 2 illustrates a two-view lenticular-based display system. Display system 200 divides the horizontal resolution of the display into two. One of two visible images consists of every second column of pixels and the other image consists of the other columns. The two images are captured or generated so that each one is appropriate for each of the viewers' eyes. In a display system providing additional views (e.g., a five-view or a nine-view system), the resolution loss is even higher and ultimately results in degraded image quality.

A simple solution to this resolution loss problem is to have the 3D sheet 110 be removable, such that it is mounted to the display 105 when the viewer 125 sees 3D movies, plays 3D games, and so on, and removed during normal use. Alternatively, the 3D sheet may be switchable so that it can be turned on when 3D images are desired and off otherwise. Unfortunately, in the process of making choices about the 3D movie or game to play, current software associated with the display 105 is not aware of the limited resolution and aliasing created by the 3D sheet 110 and keep showing small text that cannot be read when the 3D sheet 110 is over the display 105 (when it is removable) or switched on (when it is switchable), forcing the viewer 125 to repeatedly remove and put back the 3D sheet 110 or turn it off.

Having the 3D sheet 110 be removable, however, requires that 3D sheet 110 be aligned with the display 105 and the display 105 be calibrated every time the 3D sheet 110 is moved and changes position. Calibration with a 3D sheet such as 3D sheet 110 is usually performed by showing the viewer (e.g., viewer 125) some patterns until it is determined which sub-pixels are visible from a given view point and the viewer decides that the image displayed looks right. Interleaved left-right eye patterns in the display create left-eye and right-eye images at different viewing positions, but these positions change with the alignment of the 3D sheet with the display.

In small handheld devices (e.g., mobile phones), it is possible to rotate the device until the position of the 3D sheet and the views produced by it are correct. With larger devices (e.g., tablets, laptops, desktops, TVs, etc.), rotating the device may not be possible so that the pattern position can be changed by using tracking software to track the position of the viewers eyes. However, tracking can only work if there is a calibration stage before use, since the position of the 3D sheet can change slightly each time the 3D sheet is re-installed onto the display, and even pixel-size displacements can significantly degrade image quality. To address the loss in resolution and the alignment/calibration problem, various embodiments as described herein below are incorporated into the display system 100.

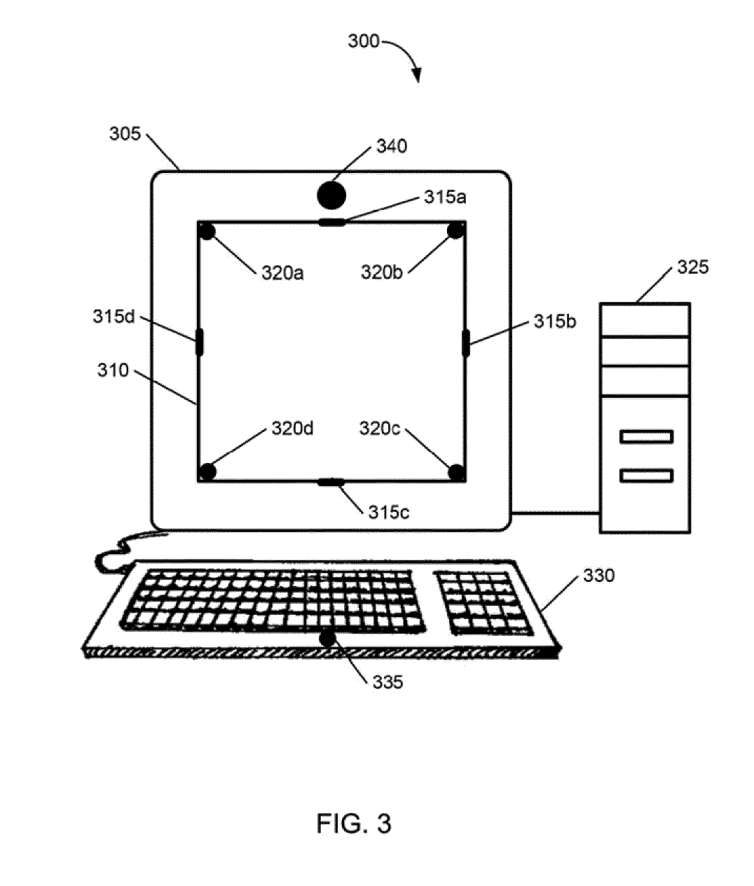

Attention is now directed to FIG. 3, which illustrates an example of a locking mechanism for aligning a removable 3D sheet with a display in an adaptive monoscopic and stereoscopic display system. Display system 300 has a display 305 and a 3D sheet 310 mounted on top of the screen of the display 305. In one embodiment, one or more locks 315a-d are attached to the display 305 to hold 3D sheet 310 in place and prevent it from moving when it is mounted to the display 305. The 3D sheet 310 may be mounted on top of the display 305 by a viewer putting it in place or sliding it in to fit the display 305. In this latter case, locks 315a-d may be slider locks or any other type of lock that may be used to hold the 3D sheet 310 in place.

To facilitate alignment of the 3D sheet 310 with the pixels in the display 305, one or more sensors 320a-d may be used together with the locks 315a-d. The sensors 320a-d enable a computer 325 controlling the display 305 to detect when the 3D sheet 310 is mounted on top of the display 305. The sensors 320a-d may also be able to estimate precisely the position of the 3D sheet 310 relative to the pixels in the display 305. Any correction that needs to be made to properly and accurately align the 3D sheet 310 with the pixels in the display 305 can be directed by software in the computer 325, which controls the operation of display 305. For example, corrections in the alignment of the 3D sheet 310 may be made by directing one or more of the locks 315a-d to re-position the 3D sheet 310 as appropriate.

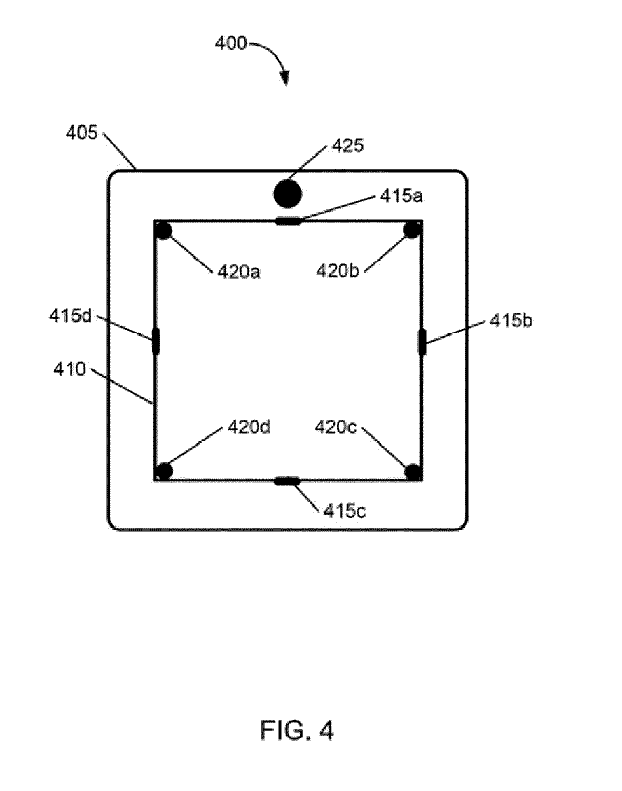

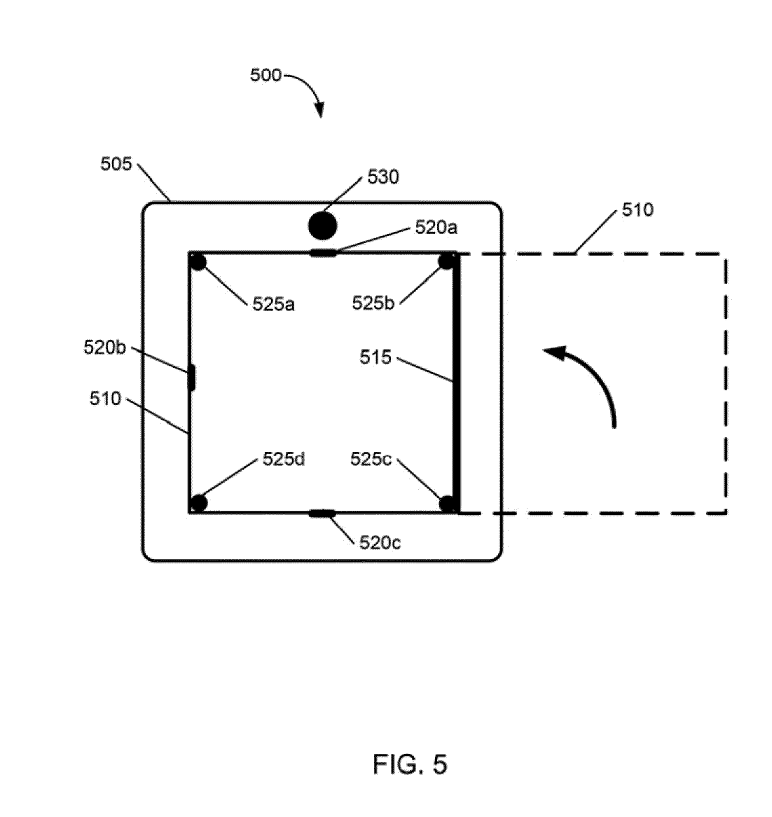

It is appreciated that the computer 325 may be integrated with the display 305 in a single device, as shown in FIGS. 4-5. It is also appreciated that locks 315a-d are positioned as shown for purposes of illustration only. Fewer or more locks may be used in any placement configuration without departing from a scope of the display system 300. Similarly, it is appreciated that sensors 320a-d are positioned as shown for purposes of illustration only. Fewer or more sensors may be used in any placement configuration without departing from a scope of the display system 300. It is further appreciated that each one or more of the sensors 320a-d may be used for a different purpose. For example, one or more of the sensors 320a-d may be used to detect the presence of the 3D sheet 310 and another one or more of the sensors 320a-d may be used to estimate the position of the 3D sheet 310 relative to the pixels in the display 305.

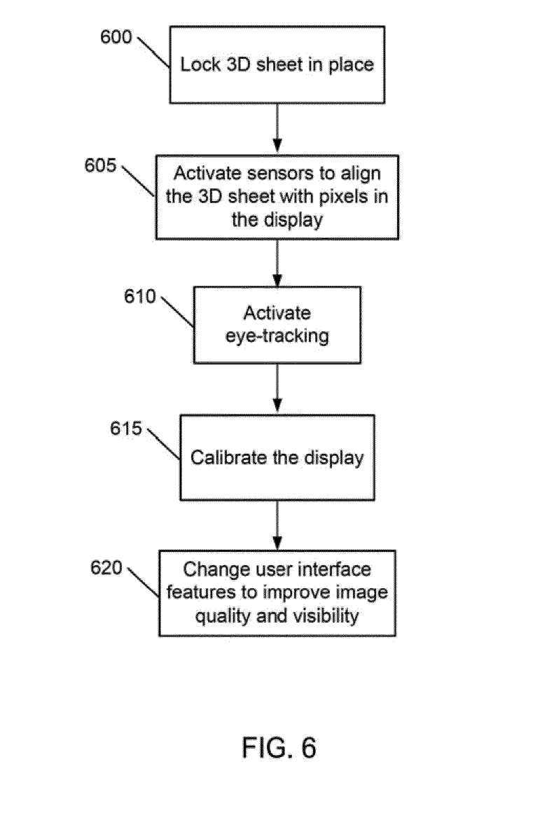

In one embodiment, one or more additional sensors may be installed on a keyboard 330 connected to the display 305 to help identify and correct the alignment of the 3D sheet 310 relative to the pixels in the display 305. These sensors, such as, for example, the sensor 335 in the keyboard 330, may be directional light sensors to measure direct light emitted by the display 305 when a sweeping pattern or other such image is displayed during calibration. As described herein below with reference to FIG. 6, the display 305 is automatically calibrated after alignment of the 3D sleet 310 to determine which pixels are visible from a given view point and to target the views according to the position of a viewer's eyes, which is determined via eye-tracking software in the computer 325.

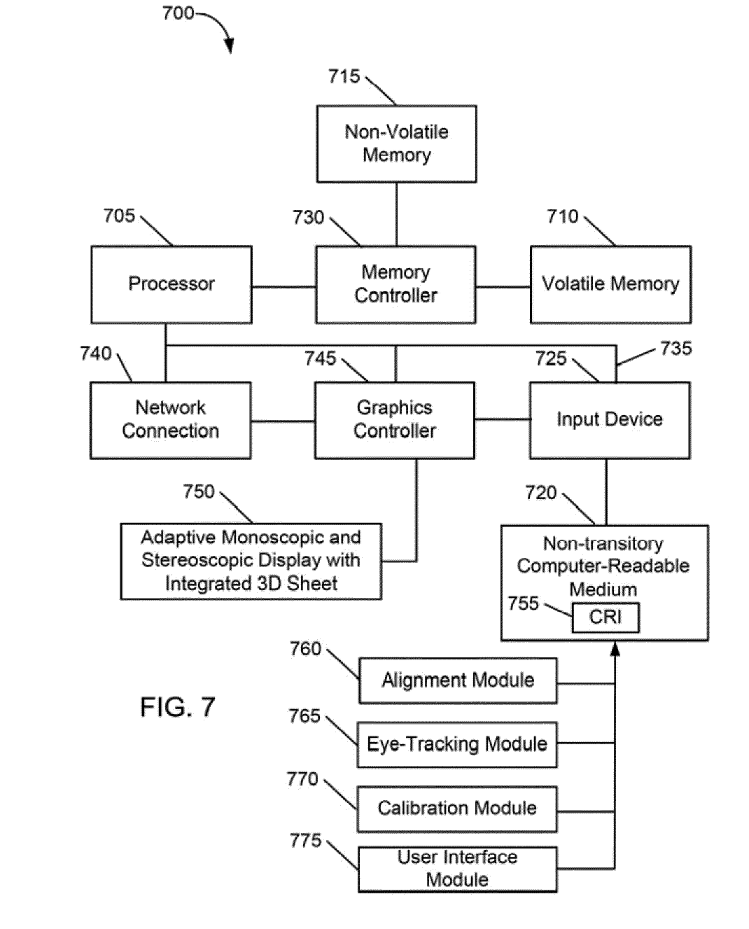

As described in more detail herein below with reference to FIGS. 6 and 7, computer 325 has software modules for controlling the display 305, including an alignment module, an eye-tracking module, a calibration module, and a user interface module. The alignment module directs locks in the display 305 to align the removable 3D sheet 310 with the pixels in the display 305 to prevent it from moving into place. The eye-tracking module detects and tracks the position of a viewer's eyes and trigger features that may facilitate the detection and tracking, such as, for example, removing any infrared LEDs to facilitate eye detection, and so on. The calibration module calibrates the display 305 to determine which pixels are visible from a given view point and target the views according to the position of the viewer's eyes. The user interface module adapts the user interface displayed to the viewer on display 305 to account for the presence of the 3D sheet 310. The user interface modifications may include, for example, displaying a large font, icons, and other imagery so they're visible to the viewer, and adding blurring to reduce aliasing.

Referring now to FIG. 4, another example of a locking mechanism for aligning a removable 3D sheet with a display in an adaptive monoscopic and stereoscopic display system is described. In this case, display system 400 may be a mobile device or other device with a display 405 and one or more processors (not shown) integrated in a single unit. A 3D sheet 410 is mounted on top of the screen of the display 405, much like the 3D sheet 310 mounted on top of the screen of the display 305 shown in FIG. 3. In one embodiment, one or more locks 415a-d are attached to the display 405 to hold the 3D sheet 410 in place and prevent it from moving when it is mounted to the display 405. The 3D sheet 410 may be mounted on top of the display 405 by a viewer putting it in place or sliding it in to fit the display 405. In this latter case, locks 415a-d may be slider locks or any other type of lock that may be used to hold the 3D sheet 410 in place.

To facilitate alignment of the 3D sheet 410 with the pixels in the display 405, one or more sensors 420a-d may be used together with the locks 415a-d. The sensors 420a-d enable the one or more processors integrated with and controlling the display 405 to detect when the 3D sheet 410 is mounted on top of the display 405. The sensors 420a-d may also be able to estimate precisely the position of the 3D sheet 410 relative to the pixels in the display 405. Any correction that needs to be made to properly and accurately align the 3D sheet 410 with the pixels in the display 405 can be directed by software in the one or more processors integrated with the display 405. For example, corrections in the alignment of the 3D sheet 410 may be made by directing one or more of the locks 415a-d to re-position the 3D sheet 410 as appropriate.

It is appreciated that locks 415a-d are positioned as shown for purposes of illustration only. Fewer or more locks may be used in any placement configuration without departing from a scope of the display system 400. Similarly, it is appreciated that sensors 420a-d are positioned as shown for purposes of illustration only. Fewer or more sensors may be used in any placement configuration without departing from a scope of the display system 400. It is further appreciated that each one or more of the sensors 420a-d may be used for a different purpose. For example, one or more of the sensors 420a-d may be used to detect the presence of the 3D sheet 410 and another one or more of the sensors 420a-d may be used to estimate the position of the 3D sheet 410 relative to the pixels in the display 405.

As described in more detail herein below with reference to FIGS. 6 and 7, the one or more processors controlling display the 405 has software modules for controlling display 405, including an alignment module, an eye-tracking module, a calibration module, and a user interface module. The alignment module directs locks in the display 405 to align the removable 3D sheet 410 with the pixels in the display 405 to prevent it from moving into place. The eye-tracking module detects and tracks the position of a viewer's eyes and trigger features that may facilitate the detection and tracking, such as, for example, removing any infrared LEDs to facilitate eye detection, and so on. The calibration module calibrates the display 405 to determine which pixels are visible from a given view point and target the views according to the position of the viewer's eyes. The user interface module adapts the user interface displayed to the viewer on display 405 to account for the presence of the 3D sheet 410. The user interface modifications may include, for example, displaying a large font, icons, and other imagery so they're visible to the viewer, and adding blurring to reduce aliasing.

Another example of a locking mechanism for aligning a removable 3D sheet with a display in an adaptive monoscopic and stereoscopic display system is illustrated in FIG. 5. In this case, a 3D sheet 510 is mounted onto the display 505 in display system 500 by first attaching or sliding the 3D sheet 510 into lock 515 and then moving or turning it in place (as indicated by the arrow) to fit the screen of the display 505. One or more locks 520a-c may also be attached to the display 505 to hold the 3D sheet 510 in place and prevent it from moving when it is mounted to the display 505.

It is appreciated that lock 515 is positioned on the right side of display 505 for purposes of illustration only. Lock 515 may be positioned on the left or on the top or bottom of display 505, without departing from a scope of the display system 500. Further, two parallel locks my be used to hold the 3D sheet 510 in place when it slides it into the display 505, such as, for example, a lock 515 on the left of the display and a similar lock on the right of the display.

To facilitate alignment of the 3D sheet 510 with the pixels in the display 505, one or more sensors 525a-d may be used together with the locks 515 and 520a-c. The sensors 525a-d enable one or more processors (not shown) integrated with and controlling the display 505 to detect when the 3D sheet 510 is mounted on top of the display 505. The sensors 525a-d may also be able to estimate precisely the position of the 3D sheet 510 relative to the pixels in the display 505. Any correction that needs to be made to properly and accurately align the 3D sheet 510 with the pixels in the display 505 can be directed by software in the one or more processors integrated with the display 505. For example, corrections in the alignment of the 3D sheet 510 may be made by directing one or more of the locks 515 and 520a-c to re-position the 3D sheet 510 as appropriate.

It is appreciated that locks 515 and 520a-c are positioned as shown for purposes of illustration only. Fewer or more locks may be used in any placement configuration without departing from a scope of the display system 500. Similarly, it is appreciated that sensors 525a-d are positioned as shown for purposes of illustration only. Fewer or more sensors may be used in any placement configuration without departing from a scope of the display system 500. It is further appreciated that each one or more of the sensors 525a-d may be used for a different purpose. For example, one or more of the sensors 525a-d may be used to detect the presence of the 3D sheet 510 and another one or more of the sensors 525a-d may be used to estimate the position of the 3D sheet 510 relative to the pixels in the display 505.

As described in more detail herein below with reference to FIGS. 6 and 7, the one or more processors controlling the display 505 has software modules for controlling the display 505, including an alignment module, an eye-tracking module, a calibration module, and a user interface module. The alignment module directs locks in the display 505 to align the removable 3D sheet 510 with the pixels in the display 505 to prevent it from moving into place. The eye-tracking module detects and tracks the position of a viewer's eyes and trigger features that may facilitate the detection and tracking, such as, for example, removing any infrared LEDs to facilitate eye detection, and so on. The calibration module calibrates the display 505 to determine which pixels are visible from a given view point and target the views according to the position of the viewer's eyes. The user interface module adapts the user interface displayed to the viewer on display 505 to account for the presence of the 3D sheet 510. The user interface modifications may include, for example, displaying a large font, icons, and other imagery so they're visible to the viewer, and adding blurring to reduce aliasing.

Referring now to FIG. 6, an example flowchart for operating an adaptive monoscopic and stereoscopic display system is described. First, a 3D sheet is mounted to a display by locking it into place with one or more locks integrated with the display (600). For example, the 3D sheet 310 is mounted to the display 305 with one or more of the locks 315a-d, the 3D sheet 410 is mounted to the display 405 with one or more of the locks 415a-d, and the 3D sheet 510 is mounted to the display 505 with one or more of the locks 515 and 520a-c. The locks prevent the 3D sheet from moving when it is mounted to the display and causing any degradation to image quality that may occur as result of a displacement. It is appreciated that the 3D sheet may be a removable or a switchable sheet.

Once the 3D sheet is mounted to the display and locked into place, software in a computer and/or processor(s) controlling the display activates one or more sensors to align the 3D sheet with the pixels in the display (605). These sensors may be sensors integrated with the display (e.g., sensors 320a-d in FIG. 3, sensors 420a-d in FIG. 4, and sensors 525a-d in FIG. 5) to enable a computer and/or processor(s) controlling the display to detect when the 3D sheet is mounted to the display. The sensors may also be able to estimate precisely the position of the 3D sheet relative to the pixels in the display. Any correction that needs to be made to properly and accurately align the 3D sheet with the pixels in the display can be directed by software in the computer and/or processor(s) controlling the display. For example, corrections in the alignment of the 3D sheet may be made by directing one or more of the locks to re-position the 3D sheet as appropriate.

One or more additional sensors may also be installed on a keyboard connected to the display (e.g., sensor 335 in the keyboard 330 in FIG. 3) to help identify and correct the alignment of the 3D sheet relative to the pixels in the display. These keyboard sensors may be directional light sensors to measure direct light emitted by the display when a sweeping pattern or other such image is displayed during calibration.

In one embodiment, an eye-tracking module is automatically triggered (610) when one or more of the sensors detect the presence of the 3D sheet mounted to the display. The eye-tracking module detects the position of a viewer's eyes and is performed by software in the computer and/or processors(s) controlling the display by using a camera integrated with the display (e.g., camera 340 in FIG. 3, camera 425 in FIG. 4, and camera 550 in FIG. 5). Features that facilitate eye-tracking may also be implemented, such as, for example removing any infrared fibers from the camera, switching infrared LEDs to facilitate eye detection (e.g., using the eye's natural ability to reflect light as observed in “red eye” photos), and so on.

The display is then automatically calibrated (615) upon detection and alignment of the 3D sheet to determine which pixels are visible from a given view point and to target the 3D sheet views according to the position of the viewer's eyes determined by the eye-tracking module in the computer and/or one or more processors controlling the display. The calibration may be performed by several techniques, such as for example, sweeping displayed white lines corresponding to an eye's view on a black background, projecting a moving light wedge and determining its position and motion as detected by the camera, and having the viewer hold a mirror when the sweeping pattern is displayed, among others.

After the display is calibrated, software in the computer and/or processor(s) integrated with the display modifies the user interface displayed to the viewer in the display to ensure that the viewer is able to see good quality and visible images and read any text on the screen (620). The user interface modifications may include, for example, displaying a larger font, icons, and other imagery so they're visible to the viewer, and adding blurring to reduce aliasing.

Attention is now directed to FIG. 7, which illustrates a block diagram of an example of a computing system 700 for controlling the adaptive monoscopic and stereoscopic display according to the present disclosure. The system 700 (e.g., a desktop computer, a laptop, or a mobile device) can include a processor 705 and memory resources, such as, for example, the volatile memory 710 and/or the non-volatile memory 715, for executing instructions stored in a tangible non-transitory medium (e.g., volatile memory 710, non-volatile memory 715, and/or computer readable medium 720) and/or an application specific integrated circuit (“ASIC”) including logic configured to perform various examples of the present disclosure.

A machine (e.g., a computing device) can include and/or receive a tangible non-transitory computer-readable medium 720 storing a set of computer-readable instructions (e.g., software) via an input device 725. As used herein, the processor 705 can include one or a plurality of processors such as in a parallel processing system. The memory can include memory addressable by the processor 705 for execution of computer readable instructions. The computer readable medium 720 can include volatile and/or non-volatile memory such as a random access memory (“RAM”), magnetic memory such as a hard disk, floppy disk, and/or tape memory, a solid state drive (“SSD”), flash memory, phase change memory, and so on. In some embodiments, the non-volatile memory 715 can be a local or remote database including a plurality of physical non-volatile memory devices.

The processor 705 can control the overall operation of the system 700. The processor 705 can be connected to a memory controller 730, which can read and/or write data from and/or to volatile memory 710 (e.g., RAM). The memory controller 730 can include an ASIC and/or a processor with its own memory resources (e.g., volatile and/or non-volatile memory). The volatile memory 710 can include one or a plurality of memory modules (e.g., chips).

The processor 705 can be connected to a bus 735 to provide communication between the processor 705, the network connection 740, and other portions of the system 700. The non-volatile memory 715 cap provide persistent data storage for the system 700. Further, the graphics controller 745 can connect to an adaptive monoscopic and stereoscopic display 750, which has a removable 3D sheet to provide a 3D image to a viewer based on activities performed by the system 700. The display 750 may also include integrated looks, sensors, and a camera, as described herein above with reference to displays 305, 405, and 505 in FIGS. 3, 4, and 5, respectively.

Each system 700 can include a computing device including control circuitry such as a processor, a state machine, ASIC, controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g., the non-transitory computer-readable medium 720). The non-transitory computer-readable medium 720 can be integral, or communicatively coupled, to a computing device, in either a wired or wireless manner. For example, the non-transitory computer-readable medium 720 can be an internal memory, a portable memory, a portable disk, or a memory located internal to another computing resource (e.g., enabling the computer-readable instructions to be downloaded over the Internet).

The non-transitory computer-readable medium 720 can have computer-readable instructions 755 stored thereon that are executed by the control circuitry (e.g., processor) to control the adaptive monoscopic and stereoscopic display system according to the present disclosure. For example, the non-transitory computer medium 720 can have computer-readable instructions 755 for implementing an alignment module 760, an eye-tracking module 765, a calibration module 770, and a user interface module 775. The alignment module 760 directs locks in the display 750 to align the removable 3D sheet with the pixels in the display 750 to prevent it from moving into place. The eye-tracking module 765 detects and tracks the position of a viewer's eyes and trigger features that may facilitate the detection and tracking, such as, for example, removing any infrared LEDs to facilitate eye detection, and so on. The calibration module 770 calibrates the display 750 to determine which pixels are visible from a given view point and target the views according to the position of the viewers eyes. The user interface module 775 adapts the user interface displayed to the viewer on display 750 to account for the presence of the 3D sheet. The user interface modifications may include, for example, displaying a large font, icons, and other imagery so they're visible to the viewer, and adding blurring to reduce aliasing.

The non-transitory computer-readable medium 720, as used herein, can include volatile and/or non-volatile memory. Volatile memory can include memory that depends upon power to store information, such as various types of dynamic random access memory (“DRAM”), among others. Non-volatile memory can include memory that does not depend upon power to store information. Examples of non-volatile memory can include solid state media such as flash memory, EEPROM, and phase change random access memory (“PCRAM”), among others. The non-transitory computer-readable medium 720 can include optical discs, digital video discs (“DVD”), Blu-Ray Discs, compact discs (“CD”), laser discs, and magnetic media such as tape drives, floppy discs, and hard drives, solid state media such as flash memory, EEPROM, PCRAM, as well as any other type of computer-readable media.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. For example, it is appreciated that the present disclosure is not limited to a particular computing system configuration, such as computing system 700.

Those of skill in the art would further appreciate that the various illustrative modules and steps described in connection with the embodiments disclosed herein may be implemented as electronic hardware, computer software, or combinations of both. For example, the example steps of FIG. 6 may be implemented using software modules, hardware modules or components, or a combination of software and hardware modules or components. Thus, in one embodiment, one or more of the example steps of FIG. 6 may comprise hardware modules or components (e.g., sensors, locks, and cameras as described above with reference to FIGS. 3-5). In another embodiment, one or more of the steps of FIG. 6 may comprise software code stored on a computer readable storage medium, which is executable by a processor.

To clearly illustrate this interchangeability of hardware and software, various illustrative components, blocks, modules, and steps have been described above generally in terms of their functionality (e.g., the alignment of the 3D sheet with the pixels in the display in the alignment module 760, the eye-tracking in the eye-tracking module 765, the calibration in the calibration module 770, and the user interface modifications in the user interface module 775). Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. An adaptive monoscopic and stereoscopic display system, comprising:
a display integrated with at least one lock and at least one sensor;
a 3D sheet integrated to the display using the at least one lock; and
a processor to adapt the display according to whether the 3D sheet is integrated to the display.

2. The adaptive monoscopic and stereoscopic display system of claim 1, wherein the at least one lock is attached to the display to hold the 3D sheet in place and prevent it from moving.

3. The adaptive monoscopic and stereoscopic display system of claim 1, wherein the at least one lock comprises a slider lock.

4. The adaptive monoscopic and stereoscopic display system of claim 1, wherein the at least one sensor detects when the 3D sheet is mounted to the display.

5. The adaptive monoscopic and stereoscopic display system of claim 4, wherein the at least one sensor estimates a position of the 3D sheet relative to pixels in the display.

6. The adaptive monoscopic and stereoscopic display system of claim 1, further comprising at least one directional sensor in a keyboard connected to the display.

7. The adaptive monoscopic and stereoscopic display system of claim 1, wherein the display comprises a camera.

8. The adaptive monoscopic and stereoscopic display system of claim 1, wherein the processor comprises an alignment module to align the 3D sheet with pixels in the display.

9. The adaptive monoscopic and stereoscopic display system of claim 1, wherein the processor comprises an eye-tracking module to detect and track a position of a viewer's eyes.

10. The adaptive monoscopic and stereoscopic display system of claim 1, wherein the processor comprises a calibration module to calibrate the display.

11. The adaptive monoscopic and stereoscopic display system of claim 1, wherein the processor comprises a user interface module to adapt a user interface on the display when the 3D sheet is mounted to the display.

12. A computer readable storage medium, comprising executable instructions to:
align a 3D sheet to a display, the 3D sheet mounted to the display using at least one lock integrated with the display;
track a position of a viewer's eyes;
calibrate the display; and
modify a user interface displayed to the viewer in the display when the 3D sheet is mounted to the display.

13. The computer readable storage medium of claim 12, wherein the executable instructions to align the 3D sheet to the display comprise executable instructions to activate at least one sensor integrated with the display to verify the alignment.

14. The computer readable storage medium of claim 12, wherein the executable instructions to track a position of a viewer's eyes comprise executable instructions to remove an infrared filter from a camera in the display.

15. The computer readable storage medium of claim 12, wherein the executable instructions to calibrate the display comprise executable instructions to display a sweeping pattern to the viewer.

16. The computer readable storage medium of claim 12, wherein the executable instructions to modify the user interface comprise executable instructions to increase a size of fonts displayed to the viewer in the display when the 3D sheet is mounted to the display.

17. The computer readable storage medium of claim 12, wherein the executable instructions to modify the user interface comprise executable instructions to add blurring to images displayed in the display when the 3D display is mounted to the display.

18. A processor to control an adaptive monoscopic and stereoscopic display having a removable 3D sheet mounted to the display, the processor comprising:
an alignment module to align the removable 3D sheet to the display using at least one lock and at least one sensor integrated with the display;
a calibration module to calibrate the display; and
a user interface module to modify a user interface displayed to a viewer in the display when the removable 3D sheet is mounted to the display.

19. The processor of claim 18, further comprising an eye-tracking module to track a position of the viewer's eyes.

20. The processor of claim 18, wherein the user interface module increases a size of fonts displayed to the viewer in the display when the removable 3D sheet is mounted to the display.
